(19) United States
(12) Patent Application Publication
(10) Pub. No.: US 2007/0274542 A1
(43) Pub. Date: Nov. 29, 2007

(54) Damper for speaker device and speaker device

(75) Inventor: Hayato Otomo, Yamagata (JP)

Correspondence Address: NIXON & VANDERHYE, PC, 901 NORTH GLEBE ROAD, 11TH FLOOR, ARLINGTON, VA, 22203, US

(73) Assignees: PIONEER CORPORATION, Tokyo (JP); TOHOKU PIONEER CORPORATION, Yamagata (JP)

(21) Appl. No.: 11/802,421

(22) Filed: May 22, 2007

(30) Foreign Application Priority Data
May 24, 2006 (JP) 2006-143711

(51) Int. Cl. H04R 25/00

(52) U.S. Cl. 381/150

(57) ABSTRACT

A damper includes an outer peripheral frame (first annular part), an inner peripheral frame (second annular part) arranged on an inner side of the outer peripheral frame, and first and second arms. The first and second arms have the elasticity, and are arranged between the outer peripheral frame and the inner peripheral frame to integrate the outer peripheral frame and the inner peripheral frame. The first and second arms have plural arm parts. The plural arm parts forming the first arm frame and the plural arm parts forming the second arm are arranged with distances in a generating line direction of the outer peripheral frame and the inner peripheral frame. The first arm is positioned on a first plane surface different from a second plane surface on which the second arm is positioned.

### BACKGROUND OF THE INVENTION

1. Field of the Invention

The present invention relates to a configuration of a damper for a speaker device.

2. Description of Related Art

Conventionally, there are known various kinds of dampers for speaker devices such as a corrugation-shaped damper, a gathered-shaped damper and a butterfly-shaped damper.

The butterfly-shaped damper generally includes an inner peripheral frame having an annular shape, an outer peripheral frame having an annular shape and having a diameter larger than the inner peripheral frame, and plural arm parts for integrating the inner peripheral frame and the outer peripheral frame. For example, the butterfly-shaped damper having such a configuration is disclosed in Japanese Patent Application Laid-open under No. 2002-262391 (Reference-1).

In the butterfly-shaped damper according to Reference-1, one end of the arm part is integrated with the outer peripheral frame so that, at an integration part of the arm part corresponding to the outer peripheral frame, a part of the outer peripheral frame is attached to both sides of the arm part with respect to a driving direction of the damper. Thus, even if the inner peripheral frame is vibrated due to driving of the damper, the part of the outer peripheral frame serves as a wall, and a large vibration of the arm part can be suppressed. Hence, a stress thereof can be reduced.

In addition, other examples of the damper having the configuration of this kind are disclosed in Japanese Patent Applications Laid-open under No. 2003-97641 (Reference-2), No. 2003-219497 (Reference-3) and No. 2003-32788 (Reference-4).

The damper according to Reference-2 has a damper main body which is manufactured by injection molding of thermoplastic elastomer. The damper main body includes a voice coil attachment part, a damper peripheral edge part attached to a frame, a suspension lever for elastically bridging the voice coil attachment part and the damper peripheral edge part, and a watermark window. The two damper main bodies are overlapped and sandwich mesh therebetween to be manufactured by insert mold. By this configuration, a free vibration characteristic and softness degree with preferred durability and soft grade can be realized. Therefore, the damper has a significant effect of dense dustproofness.

The damper according to Reference-3 includes a small diameter cylindrical part with which a bobbin, which a voice coil bobbin is wound around, engages, a large diameter cylindrical part fixed to a speaker frame, and an arm part for bridging the small diameter cylindrical part and the large diameter cylindrical part. Particularly, a small cylindrical integration part and a large cylindrical integration part of the arm part are integrated with the vicinity of one-side open surfaces of the small diameter cylindrical part and the large diameter cylindrical part, and the small cylindrical integration part and the large cylindrical integration part of the arm part on the other side are integrated with the vicinity of other side open surfaces of the small diameter cylindrical part and the large diameter cylindrical part. Thereby, the arm part of the damper for the speaker device and the bobbin (small diameter cylindrical part) are integrated with each other at two different parts in the axis direction of the bobbin. Even if the bobbin moves in the axis direction, the bobbin rolling hardly occurs.

The damper according to Reference-4 includes a first damper member and a second damper member. The first damper member has an open surface on a side of one end surface, a hole for mounting the voice coil at a center thereof on a side of the other end surface, and a damper part flexible in the movement direction of the voice coil. Moreover, the first damper member and the second damper member are integrated (i.e., double damper structure) so that the open surface of the first damper member and the open surface of the second damper member become opposite. Thereby, since a cylindrical surface of the first damper member and a cylindrical surface of the second damper member serve as a spacer for maintaining a space between the two damper parts, a spacer becomes unnecessary. Thus, the number of assembly procedures is reduced, and the cost can be also reduced.

Since the damper according to Reference-2 and 4 of the above References-1 to 4 is formed by combining the two damper members (or damper main bodies), it seems that a vibration system member including the voice coil bobbin and a diaphragm can be stably vibrated, as compared with a single damper. However, since the damper is made of the two damper members (or damper main bodies), it is problematic that the manufacturing cost of the damper becomes high and thus the manufacturing cost of the speaker device also becomes high.

### SUMMARY OF THE INVENTION

The present invention has been achieved in order to solve the above problem. It is an object of this invention to provide a damper for a speaker device and a speaker device, having the same configuration as that of a double structure damper, capable of reducing manufacturing cost and stably vibrating a vibration system member.

According to one aspect of the present invention, there is provided a damper for a speaker device including: a first annular part; a second annular part which is arranged on an inner side of the first annular part; and first and second arms which have elasticity, which are arranged between the first annular part and the second annular part, and which integrate the first annular part and the second annular part, wherein the first arm and the second arm are arranged with a distance in a generating line direction of the first annular part and the second annular part, and wherein the first arm is positioned on a first plane surface different from a second plane surface on which the second arm is positioned.

The above damper for the speaker device includes the first annular part mounted on the frame, and the second annular part mounted on the voice coil bobbin around which the voice coil is wound and arranged on the inner side of the first annular part, and the first and second arms having elasticity, arranged between the first annular part and the second annular part so as to integrate the first annular part and the second annular part. The first arm and the second arm are arranged with the distance in the generating line direction of the first annular part and the second annular part, and the first arm is positioned on the first plane surface different from the second plane surface on which the second arm is positioned. The generating line direction is a direction perpendicular with respect to each of one-end surfaces of the first and second annular parts and each of the other-end surfaces of them corresponding to each of the one-end surface of them.

Namely, the damper for the speaker device according to the invention has such a configuration that a double damper structure normally formed by overlapping two butterfly-shaped dampers is realized by a single butterfly-shaped damper.

Thereby, in the speaker device employing the damper for the speaker device according to the invention, the rolling of the vibration system member including the voice coil bobbin hardly occurs, as compared with the speaker device including the single damper. Therefore, the vibration system member can be stably vibrated in the above generating line direction.

Additionally, since the known double structure damper (double damper) has the configuration including the two dampers, the manufacturing cost of the damper becomes high by the amount. Meanwhile, in the damper for the speaker device according to the invention, the double damper structure can be realized by the single damper. Hence, the manufacturing cost of the damper for the speaker device can be reduced, as compared with the above known double damper. Thereby, the manufacturing cost of the speaker device can be also reduced.

In a manner of the above damper for the speaker device, each of the first arm and the second arm may have plural arm parts arranged with a constant space in a circumferential direction of the first annular part and the second annular part, and it may be prescribed that the plural arm parts forming the first arm and the plural arm parts forming the second arm do not planarly overlap with each other in the generating line direction. In a preferred example, the plural arm parts may be formed into an S shape. Therefore, when the damper for the speaker device is manufactured by an injection molding method, manufacturing of the first arm and the second arm becomes easy.

In another manner of the above damper for the speaker device, the plural arm parts forming the first arm and the plural arm parts forming the second arm may be alternately arranged with constant spaces in the circumferential direction.

Thereby, the vibration system member including the voice coil bobbin can be stably vibrated in the above generating line direction, and it can be prevented that the rolling occurs in the vibration system member.

According to another aspect of the present invention, there is provided a speaker device including: the above damper for a speaker device; a voice coil bobbin around which a voice coil is wound; and a frame, wherein the first annular part is mounted on the frame, and the second annular part is mounted on the voice coil bobbin. Thereby, it becomes possible to form the speaker device having the same operation as that of the speaker device having the known double dampers. Therefore, the vibration system member including the voice coil bobbin can be stably vibrated in the generating line direction and the central axis direction of the speaker device, and it can be prevented that the rolling occurs in the vibration system member. In addition, since the double damper structure can be realized by the single damper for the speaker device in the present invention, the manufacturing cost of the damper for the speaker device can be low, and further the manufacturing cost of the speaker device can be also low.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIG. 1 shows a cross-sectional view of a speaker device including a damper according to an embodiment of the present invention;

FIGS. 2A and 2B show a perspective view and a plan view of the damper according to this embodiment; and

FIG. 3 shows a cross-sectional view of the damper according to this embodiment.

### DETAILED DESCRIPTION OF THE PREFERRED EMBODIMENTS

Now, a preferred embodiment of the present invention will be described below with reference to the attached drawings.

### [Configuration of Speaker Device]

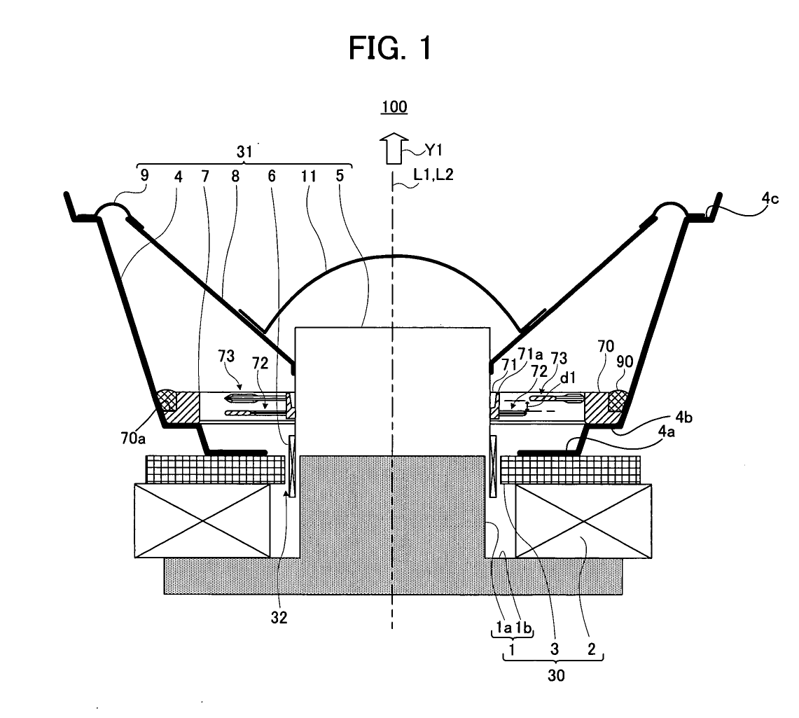

FIG. 1 shows a cross-sectional view of a speaker device 100 including a damper 7 according to an embodiment of the present invention, when cut by a plane surface passing through a central axis L1 thereof.

As shown in FIG. 1, the speaker device 100 includes a magnetic circuit 30 including a yoke 1, a magnet 2 and a plate 3; a frame 4; and a vibration system member 31 including a voice coil bobbin 5, a voice coil 6, a damper 7, a diaphragm 8, an edge 9 and a cap 11. The configuration and driving system of the speaker device and the configurations of component parts (the vibration system member 31 and the magnetic circuit 30) for the speaker device other than the damper 7 are not limited in the present invention.

First, a description will be given of the configuration of the magnetic circuit 30.

The magnetic circuit 30 is configured as an external-magnet-type magnetic circuit.

The yoke 1 has a pole part la formed into a substantially cylindrical shape, and a flange part 1b outwardly extending from the lower end part of the outer peripheral wall of the pole part 1a.

The magnet 2, formed into a substantially annular shape, is mounted on the flange part 1b. The plate 3, having a substantially annular shape, is mounted on the magnet 2. A magnetic gap 32 on which the magnetic flux of the magnet 2 concentrates is formed in a gap between the inner peripheral wall of the plate 3 and the outer peripheral wall of the pole part 1a.

The frame 4 has a function to support various kinds of component members for the speaker device. The frame 4, having a substantial bowl shape and a step-state cross-section, has a first step part 4a, a second step part 4b provided on the upper and outer side of the first step part 4a, and a third step part 4c provided on the upper and outer side of the second step part 4b. The first step part 4a, being the component of the frame 4, is mounted on the plate 3. Thereby, the frame 4 is integrated with the magnetic circuit 30. The outer peripheral part of the damper 7, i.e., an outer peripheral frame 70, is arranged on the second step part 4b. In addition, the outer peripheral part of the edge 9 is arranged on the third step part 4c.

Next, a description will be given of a configuration of the vibration system member 31.

The voice coil bobbin 5 is formed into a substantially cylindrical shape. The vicinity of the lower end part of the voice coil bobbin 5 covers the vicinity of the upper end part of the pole part 1a of the yoke 1. Therefore, the vicinity of the lower end part of the inner peripheral wall of the voice coil bobbin 5 is opposite to the vicinity of the upper end part of the outer peripheral wall of the pole 1a, and the vicinity of the lower end part of the outer peripheral wall of the voice coil bobbin 5 is opposite to the inner peripheral wall of the plate 3 and a part of the inner peripheral wall of the magnet 2, respectively.

The voice coil 6 is wound around the vicinity of the lower end part of the outer peripheral wall of the voice coil bobbin 5, and the outer peripheral wall of the voice coil 6 is opposite to the inner peripheral wall of the plate 3. The voice coil 6 includes one wiring including a plus lead wire and a minus lead wire (not shown). The plus lead wire is an input wiring of an L(or R) channel signal, and the minus lead wire is an input wiring of a ground(GND) signal. Each of the plus and minus lead wires is electrically connected to a terminal (not shown) provided at an appropriate position of the frame 4, respectively, and the terminal is electrically connected to an output wiring of an amplifier (not shown), too. Thereby, one-channel signal and power are inputted to the voice coil 6 from the amplifier via the terminal and each of the plus and minus lead wires.

The damper 7, formed into a substantially annular shape, has a function to elastically support the voice coil bobbin 5. In a preferred example, the damper 7 is made of a resin material. An inner peripheral frame 71 of the damper 7 is mounted on the vicinity of the upper end part of the outer peripheral wall of the voice coil bobbin 5 via plural ribs 71a provided on the inner peripheral wall thereof, and the outer peripheral frame 70 of the damper 7 is mounted on the second step part 4b of the frame 4. Further, a reinforcing material 90 is applied to a claw part 70a provided on the outer peripheral frame 70 of the damper 7, and the damper 7 is reinforced by the frame 4 via the reinforcing material 90 and fixed thereto. The detailed configuration of the damper 7 will be explained later.

The diaphragm 8, formed into a cone shape, has a function to output an acoustic wave corresponding to an input signal. The inner peripheral edge part of the diaphragm 8 is mounted on the upper end part of the outer peripheral wall of the voice coil bobbin 5. Meanwhile, the edge 9, having a substantially Ω-shaped cross-section, is mounted on the outer peripheral edge part of the diaphragm 8. An outer peripheral edge part of the edge 9 is mounted on the third step part 4c of the frame 4.

A cap 11 is formed into a dome shape, and the vicinity of the outer peripheral edge part thereof is mounted on the sound output surface of the inner peripheral part of the diaphragm 8, being the sound output side. Thus, the cap 11 has a function to prevent moisture and foreign material from entering the magnetic circuit 30 from the sound output side.

In the speaker device 100 having the above-mentioned configuration, the signal and power outputted from the amplifier are supplied to the voice coil 6 via the terminal and the plus and minus lead wires of the voice coil 6. Thereby, the driving force is generated to the voice coil 6 in the magnetic gap 32, which makes the eccentric diaphragm 8 vibrate in the direction of the central axis L1 of the speaker device 100. In this manner, the speaker device 100 outputs the acoustic wave in the direction of an arrow Y1.

### [Configuration of Damper]

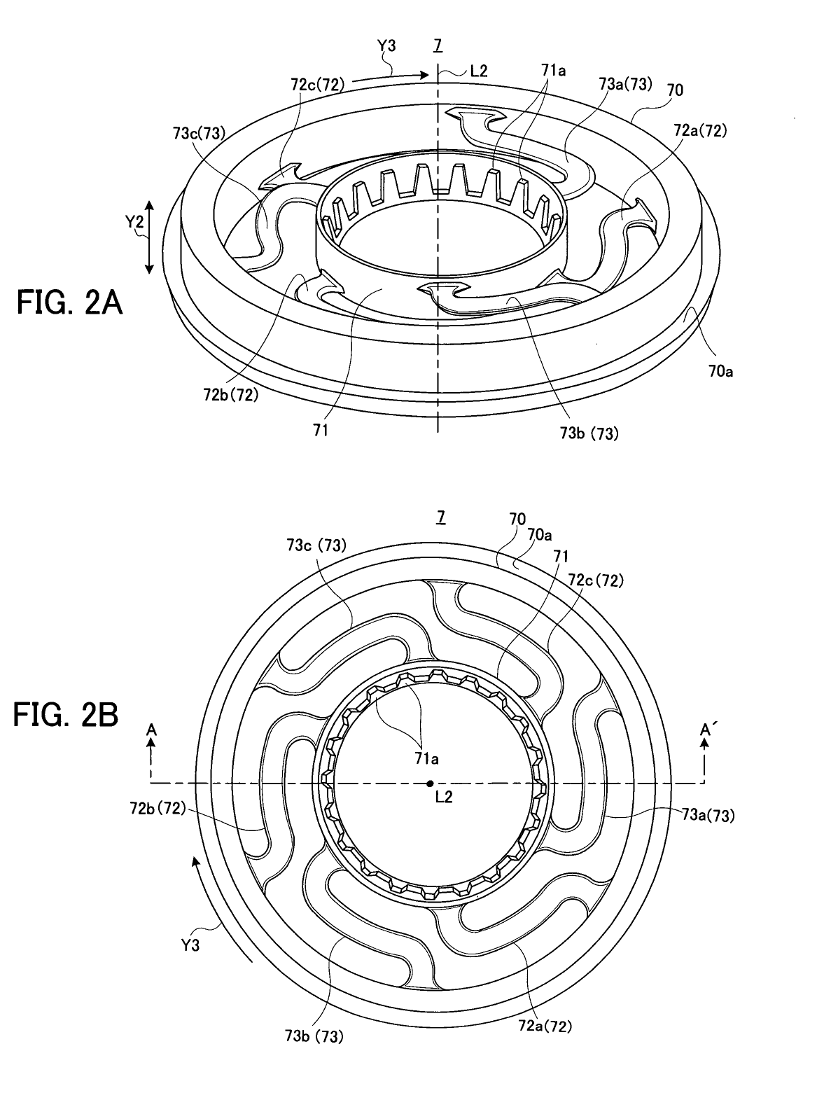

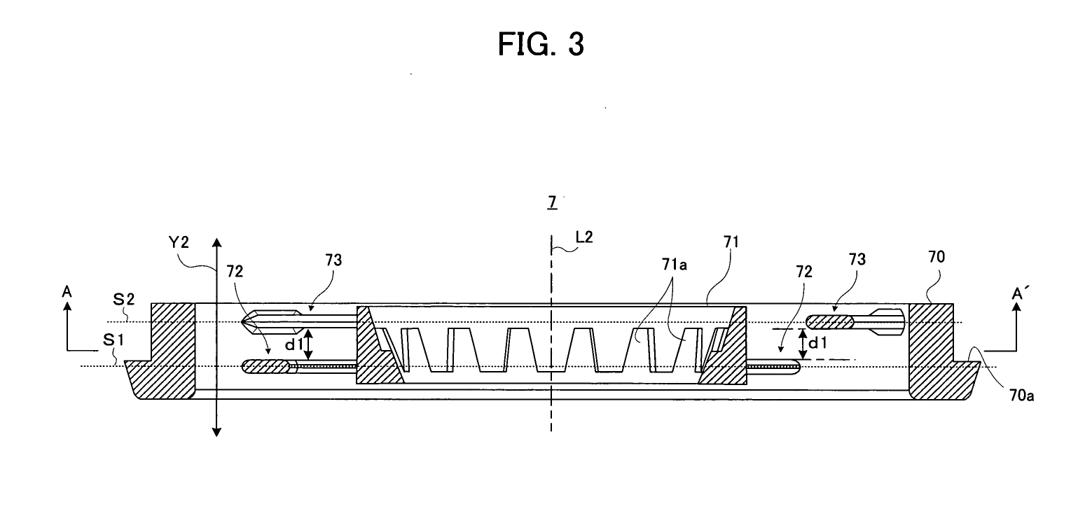

Next, a detailed description will be given of a configuration of the damper 7 according to an embodiment of the present invention, with reference to FIGS. 2A and 2B and FIG. 3.

FIG. 2A shows a perspective view of the damper 7 when observed from the side opposite to the sound output direction Y1 shown FIG. 1. FIG. 2B shows a plan view of the damper 7 when observed from the side opposite to the sound output direction Y1 shown in FIG. 1. FIG. 3 is a cross-sectional view of the damper 7 taken along a cutting line A-A′ shown in FIG. 2B, particularly when cut at a position passing through a central axis L2 of the damper 7.

The damper 7 has such a configuration that a double structure damper (double damper) formed by overlapping two butterfly-shaped dampers is realized by a single butterfly-shaped damper.

Concretely, the damper 7, which has a butterfly-shaped damper configuration, includes the outer peripheral frame (first annular part) 70 mounted on the frame 4; the inner peripheral frame (second annular part) 71 arranged on the inner side of the outer peripheral frame 70 and mounted on the voice coil bobbin 5; a first arm 72, having elasticity, arranged between the outer peripheral frame 70 and the inner peripheral frame 71, integrating the outer peripheral frame 70 and the inner peripheral frame 71 and including plural arm parts 72a, 72b and 72c; and a second arm 73, similarly having elasticity, integrating the outer peripheral frame 70 and the inner peripheral frame 71 and including the plural arm parts 73a, 73b and 73c.

The outer peripheral frame 70, formed into an annulus ring shape, has the claw part 70a outwardly projecting from the lower end part of the outer peripheral wall. The claw part 70a engages with the frame 4.

The inner peripheral frame 71 is formed into an annulus ring shape, and the internal diameter thereof is smaller than the internal diameter of the outer peripheral frame 70. The plural ribs (protrusions) 71a are formed on the inner peripheral wall of the inner peripheral frame 71. The ribs 71a have a function to stably mount the inner peripheral frame 71 on the voice coil bobbin 5. The central axis of the inner peripheral frame 71 and the central axis of the outer peripheral frame 70 are positioned on the central axis L2 of the damper 7.

The first arm 72 including the plural arm parts 72a, 72b and 72c and the second arm 73 including the plural arm parts 73a, 73b and 73c are arranged with a distance in a generating line direction Y2 of the outer peripheral frame 70 and the inner peripheral frame 71, as shown in FIG. 3. The first arm 72 is positioned on the first plane surface different from the second plane surface on which the second arm 73 is positioned. The generating line direction Y2 is a direction perpendicular with respect to each of the end surfaces (each of the upper surfaces) of the outer peripheral frame 70 and the inner peripheral frame 71 and each of the other end surfaces (each of the lower surfaces) opposite to each of the end surfaces, i.e., a direction in parallel with the central axis L2 of the damper 7, in FIG. 2A and FIG. 3. In this manner, the first arm 72 including the arm parts 72a, 72b and 72c and the second arm 73 including the arm parts 73a, 73b and 73c are arranged with a constant distance d1 in the generating line direction Y2 of the outer peripheral frame 70 and the inner peripheral frame 71.

Additionally, each of the arm parts 72a, 72b and 72c forming the first arm 72 is formed into an S shape. They are positioned on a plane surface S1 and arranged with constant spaces in the circumferential direction Y3 of the outer peripheral frame 70 and the inner peripheral frame 71. Meanwhile, each of the arm parts 73a, 73b and 73c forming the second arm 73 is also formed into an S shape. They are positioned on a plane surface S2 positioned above the plane surface S1 and arranged with constant spaces in the circumferential direction Y3 of the outer peripheral frame 70 and the inner peripheral frame 71. In addition, the arm parts 72a, 72b and 72c and the arm parts 73a, 73b and 73c do not planarly overlap with each other in the generating line direction Y2 of the outer peripheral frame 70 and the inner peripheral frame 71, from a planar point of view. In other words, the plural arm parts 72a to 72c and 73a to 73c are planarly shifted from each other in the generating line direction. Each arm part of the first arm 72, i.e., the arm parts 72a, 72b and 72c, and each arm part of the second arm 73, i.e., the arm parts 73a, 73b and 73c, are alternately arranged with constant spaces in the circumferential direction Y3 of the outer peripheral frame 70 and the inner peripheral frame 71, in the generating line direction Y2 of the outer peripheral frame 70 and the inner peripheral frame 71.

The damper having the above-mentioned configuration has operation and effect, which will be described below.

The damper 7 according to this embodiment includes the outer peripheral frame 70; the inner peripheral frame 71 arranged on the inner side of the outer peripheral frame 70; the first arm 72, having the elasticity, arranged between the outer peripheral frame 70 and the inner peripheral frame 71, integrating the outer peripheral frame 70 and the inner peripheral frame 71 and including the plural arm parts 72a, 72b and 72c; and the second arm 73, having the elasticity, integrating the outer peripheral frame 70 and the inner peripheral frame 71 and including the plural arm parts 73a, 73b and 73c. The first arm 72 and the second arm 73 are arranged with the distance in the generating line direction Y2 of the outer peripheral frame 70 and the inner peripheral frame 71, and the first arm 72 is positioned on the first plane surface different from the second plane surface on which the second arm 73 is positioned. Namely, the damper 7 has such a configuration that the double damper formed by overlapping the two butterfly-shaped dampers is realized by the single butterfly-shaped damper.

Thereby, in the speaker device 100 employing the damper 7, rolling of the vibration system member 31 including the voice coil bobbin 5 hardly occurs, as compared with the speaker device having the single damper. The vibration system member 31 can stably vibrate in the above-mentioned generating line direction Y2 and the central axis L1 direction of the speaker device 100.

In a preferred example, it is preferred that each of the arm parts 72a, 72b and 72c forming the first arm 72 is formed into the S shape and they are positioned on the plane surface S1. Additionally, it is preferred that each of the arm parts 73a, 73b and 73c forming the second arm 73 is formed into the S shape and they are positioned on the plane surface S2 positioned above the plane surface S1.

In the case of the above-mentioned double damper, since the two butterfly-shaped dampers are included, the manufacturing cost of the damper becomes high by the amount. Meanwhile, in this embodiment, since the double damper structure can be realized by the single damper, the manufacturing cost of the damper 7 can be low, as compared with the above-mentioned double damper. Thereby, the manufacturing cost of the speaker device 100 can be also low.

Additionally, in the damper 7 of this embodiment, the arm parts 72a, 72b and 72c being the components of the first arm 72, and the arm parts 73a, 73b and 73c being the components of the second arm 73, are arranged with the constant spaces in the circumferential direction Y3 of the outer peripheral frame 70 and the inner peripheral frame 71. The arm parts 72a, 72b and 72c and the arm parts 73a, 73b and 73c do not planarly overlap with each other in the generating line direction Y2 of the outer peripheral frame 70 and the inner peripheral frame 71. Therefore, when the damper 7 is manufactured by an injection molding method, it becomes easy to manufacture the first arm 72 and the second arm 73.

The arm parts 72a, 72b and 72c forming the first arm 72 and the arm parts 73a, 73b and 73c forming the second arm 73 are alternately arranged with the constant spaces in the circumferential direction Y3 of the outer peripheral frame 70 and the inner peripheral frame 71, in the generating line direction Y2 of the outer peripheral frame 70 and the inner peripheral frame 71. Thereby, the vibration system member 31 including the voice coil bobbin 5 can stably vibrate in the above-mentioned generating line direction Y2 and the central axis L1 direction of the speaker device 100, and it can be prevented that the rolling occurs in the vibration system member 31.

### [Modification]

In the above embodiment, the outer peripheral frame 70 and the inner peripheral frame 71 are formed into the annulus ring shapes, respectively. However, the present invention is not limited to this. Namely, the outer peripheral frame 70 and the inner peripheral frame 71 may be formed into annular shapes. For example, in the present invention, the outer peripheral frame 70 and the inner peripheral frame 71 may be also formed into angularly annular shapes.

Additionally, in the above embodiment, the arm parts 72a, 72b and 72c forming the first arm 72 and the arm parts 73a, 73b and 73c forming the second arm 73 are formed into the S shapes, respectively. However, the present invention is not limited to this, and the arms can be formed into various kinds of known shapes.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2006-143711 filed on May 24, 2006 including the specification, claims, drawings and summary is incorporated herein by reference in its entirety.

What is claimed is:

1. A damper for a speaker device comprising:
a first annular part;
a second annular part which is arranged on an inner side of the first annular part; and
first and second arms which have elasticity, which are arranged between the first annular part and the second annular part, and which integrate the first annular part and the second annular part,
wherein the first arm and the second arm are arranged with a distance in a generating line direction of the first annular part and the second annular part, and
wherein the first arm is positioned on a first plane surface different from a second plane surface on which the second arm is positioned.

2. The damper for the speaker device according to claim 1,
wherein each of the first arm and the second arm has plural arm parts arranged with a constant space in a circumferential direction of the first annular part and the second annular part, and
wherein the plural arm parts forming the first arm and the plural arm parts forming the second arm do not planarly overlap with each other in the generating line direction.

3. The damper for the speaker device according to claim 2,
wherein the plural arm parts forming the first arm and the plural arm parts forming the second arm are alternately arranged with constant spaces in the circumferential direction.

4. The damper for the speaker device according to claim 2, wherein the plural arm parts are formed into an S shape.

5. A speaker device comprising:
a damper for a speaker device including: a first annular part; a second annular part which is arranged on an inner side of the first annular part; and first and second arms which have elasticity, which are arranged between the first annular part and the second annular part, and which integrate the first annular part and the second annular part, the first arm and the second arm being arranged with a distance in a generating line direction of the first annular part and the second annular part, and the first arm and the second arm being positioned on different plane surfaces;
a voice coil bobbin around which a voice coil is wound; and
a frame,
wherein the first annular part is mounted on the frame, and the second annular part is mounted on the voice coil bobbin.
